(19) United States
(12) Patent Application Publication
(10) Pub. No.: US 2026/0042432 A1
(43) Pub. Date: Feb. 12, 2026

(54) BRAKE FLUID RESERVOIR

(71) Applicant: ZF Active Safety US Inc., Livonia, MI (US)

(72) Inventor: Mikel Esandi, Farmington Hills, MI (US)

(21) Appl. No.: 18/799,160

(22) Filed: Aug. 9, 2024

(51) Int. Cl. B60T 11/26

(52) U.S. Cl. CPC B60T 11/26; B60T 17/06; B60T 17/225

(57) ABSTRACT

A brake fluid reservoir for a vehicle brake system includes a housing defining a fluid chamber for brake fluid. A funnel is mounted to the housing in the fluid chamber and defines first and second chamber portions of the fluid chamber. The funnel has an inlet opening via which brake fluid flows into the funnel from the first chamber portion and an outlet opening via which the brake fluid flows into the second chamber portion from the funnel. A valve mechanism operatively cooperates with the outlet opening to at least partially prevent brake fluid from flowing through the outlet opening from the second chamber portion toward the first chamber portion.

### TECHNICAL FIELD

The present invention relates to a brake fluid reservoir for a vehicle brake system.

### BACKGROUND

Brake fluid reservoirs for vehicle brake systems are known. Typically, brake fluid reservoirs include a housing that defines a fluid chamber of brake fluid. The fluid chamber is in fluid connection with a braking circuit of the vehicle to supply brake fluid to the braking circuit. The braking circuit is designed to function in a normal operating state when the volume of brake fluid in the fluid chamber corresponds to a brake fluid level that is at or between minimum and maximum fluid levels. Leaks in and/or wear of the brake fluid reservoir and/or the components of the brake circuit, however, may result in the brake fluid level falling below the minimum fluid level to a low fluid level.

To monitor the fluid level within the fluid chamber, a fluid level detector may be provided in/on the brake fluid reservoir. An example of such a fluid level detector includes a float that moves in response to the brake fluid level and a sensor assembly that detects the movement and/or position of the float. When the float is in a position indicative of the brake fluid level being at the low fluid level, the driver of the vehicle can be notified of such low brake fluid volume via the fluid level detector.

While use of the float helps determine when the brake fluid volume is low, certain vehicle maneuvers may cause the brake fluid in the fluid chamber to be displaced in such a manner that the float sinks to the low fluid level position even when the brake fluid volume in the fluid chamber corresponds to at least the minimum fluid level. Therefore, the brake fluid displacement caused by such vehicle maneuvers may result in “false”low brake fluid volume notifications being provided to the driver.

Certain brake fluid reservoirs attempt to solve this false notification issue by increasing the distance between the minimum fluid level and the low fluid level and adding a buffer volume of brake fluid to compensate for the increased distance. These solutions, however, undesirably increase the size, weight and material costs of brake fluid reservoirs.

### SUMMARY

According to an aspect of the invention, alone or in combination with any other aspect, a brake fluid reservoir for a vehicle brake system comprises a housing defining a fluid chamber for brake fluid. A funnel is mounted to the housing in the fluid chamber and defines first and second chamber portions of the fluid chamber. The funnel has an inlet opening via which brake fluid flows into the funnel from the first chamber portion and an outlet opening via which the brake fluid flows into the second chamber portion from the funnel. A valve mechanism operatively cooperates with the outlet opening to prevent brake fluid from flowing through the outlet opening from the second chamber portion toward the first chamber portion.

According to another aspect, alone or in combination with any other aspect, the valve mechanism operatively cooperates with the outlet opening to prevent brake fluid from flowing through the outlet opening from the second chamber portion toward the first chamber portion when the volume of the brake fluid in the fluid chamber corresponds to at least a minimum fluid level.

### BRIEF DESCRIPTION OF DRAWINGS

The foregoing and other features of the invention will become apparent to one skilled in the art to which the invention relates upon consideration of the following description of the invention with reference to the accompanying drawings, in which:

FIG. 1 is a schematic illustration of an example configuration of a brake fluid reservoir of a vehicle brake system; and

FIG. 2 is a schematic illustration of another example configuration of the brake fluid reservoir of the vehicle brake system.

### DETAILED DESCRIPTION

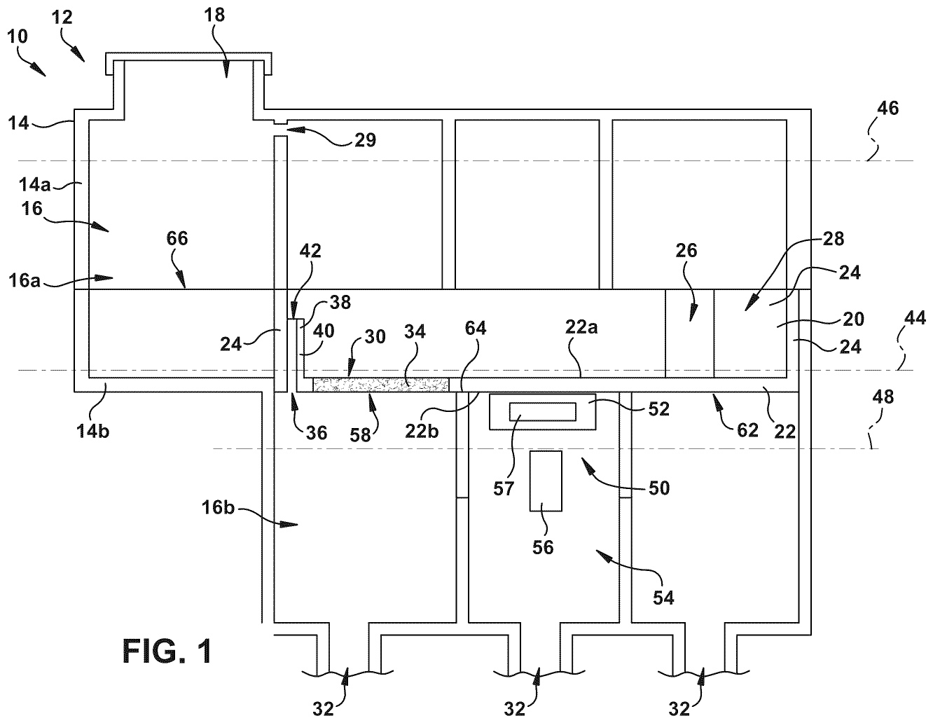

FIG. 1 depicts a brake fluid reservoir 10 for a vehicle (e.g., a motor vehicle) brake system 12. The brake fluid reservoir 10 includes a housing 14 that defines an internal fluid chamber 16 and has a fill port 18 via which the fluid chamber is filled with brake fluid. The fluid chamber 16 may be divided into first and second chamber portions 16a, 16b via a funnel 20.

The funnel 20 is separate from and mounted to the housing 14 in the fluid chamber 16. In other words, the funnel 20 is not integrally formed with the housing 14 as a single monolithic piece, it is separately formed and subsequently joined to the housing (e.g., during the construction of the housing). The funnel 20, however, in certain brake fluid reservoir configurations, may be integrally formed with the housing 14 as a single monolithic piece. The funnel 20 may have a pan-like shape with an end wall 22 and at least one side wall 24 (here, four side walls) extending vertically from an inner surface 22a of the end wall, though the funnel may have any other desired shape.

At least one of the side walls 24 includes an inlet opening 26 through which brake fluid flows into an internal funneling chamber 28 from the first chamber portion 16a. The funnel 20 and/or the housing 14 may be configured such that brake fluid typically only flows into the funneling chamber 28 via the inlet opening(s) 26 in the side wall(s) 24, though brake fluid may at least slightly flow into the funneling chamber from the first chamber portion via an one or more venting openings 29 in the housing under certain filling conditions (e.g., when the fluid chamber 16 is filled beyond a maximum fluid level 46). Furthermore, in certain configurations, the funnel 20 may also or instead include a vertical inlet opening 26 via which fluid flows over top of the side walls 24 and into the funneling chamber 28 from the first chamber portion 16a.

The end wall 22 includes an outlet opening 30 via which the brake fluid flows vertically into the second chamber portion 16b from the funneling chamber 28.

Accordingly, the second chamber portion 16b may be positioned vertically below both the first chamber portion 16a and the funnel 20, and brake fluid entering the funnel from the first chamber portion may flow in a direction that is transverse (e.g., perpendicular) to the vertical direction. It should also be noted that, in the example configuration of FIG. 1, the funnel 20 and internal walls and/or ribs of the housing 14 define the internal funneling chamber 28 such that the internal funneling chamber is separate from and fluidically between the first and second chamber portions 16a, 16b. In other configurations, however, the funneling chamber 28 may be defined solely via the funnel 20.

In general, brake fluid enters the first chamber portion 16a via the fill port 18 and flows toward the second chamber portion 16b. The second chamber portion 16b is fluidically connected to a braking circuit (not shown) of the vehicle via one or more connection ports 32 (shown here as three connection ports). The brake fluid thus is supplied to and/or received from the braking circuit via the connection ports 32.

To prevent contaminants carried by the brake fluid from entering the braking circuit, the funnel 20 may have a filter mesh 34 provided thereon. When provided, the filter mesh 34 covers the outlet opening 30 so as to prevent contaminants from passing through the outlet opening into the second chamber portion 16b. The filter mesh 34 may be formed separately from the funnel 20 and subsequently connected thereto.

Alternatively, the filter mesh 34 may be integrally formed with the funnel 20 as a single monolithic piece. The filter mesh 34 may thus be formed from a separate or the same material as the funnel 20.

It should be appreciated that brake fluid reservoirs typically include a filler neck filter in or adjacent to the fill port for catching contaminants. Therefore, via its contaminant-catching functionality, the filter mesh 34 may replace (or, alternatively, provide additional contaminant-catching support to) a filler neck filter in the brake fluid reservoir 10. When provided in place of the filler neck filter, the brake fluid reservoir 10 may be free from any additional contaminant filters between the fill port 18 and the filter mesh 34.

The funnel 20 may also include a venting opening 36 for permitting air to pass out from the second chamber portion 16b as the fluid chamber 16 is filled with brake fluid. As shown in the example configuration of FIG. 1, the venting opening 36 extends vertically through the end wall 22 and is adjacent to, but separate from the outlet opening 30. Although the venting opening 36 is shown as being adjacent to the outlet opening 30, the venting opening may be placed at any desired position on the end wall 22. For example, in one alternative configuration, the venting opening 36 may be positioned centrally on the end wall 22 relative to the side walls 24. In other words, the venting opening 36 may be located centrally on the end wall 22 in at least one direction that is perpendicular to the vertical direction.

If desired, the venting opening 36 may be at least partially surrounded on an inner surface 22a of the end wall 22 by a barrier feature 38. The barrier feature 38, when provided, at least partially urges brake fluid in the funneling chamber 28 away from the venting opening 36. In the example configuration of FIG. 1, the barrier feature 38 comprises at least one (here, a plurality) of vertically extending barrier walls 40 that surround the venting opening on the inner surface 22a of the end wall 22. The barrier feature 38 includes a vertical opening 42 that is in fluid communication with the venting opening 36 so as to “open” the venting opening to the environment of funneling chamber 28 that is external to the barrier feature 38. The barrier feature 38 thus functionally moves the access to the venting opening 36 vertically upward from the end wall 22 so as to prevent brake fluid from flowing through the venting opening until the brake fluid level rises above the opening 42 of the barrier feature.

The braking circuit is designed to be in a “normal” operating state when the volume of the brake fluid in the fluid chamber 16 corresponds to a brake fluid level that is at or between minimum and maximum fluid levels 44, 46. Leaks in and/or wear of the brake fluid reservoir 10 and/or the components of the brake circuit, however, may result in the brake fluid level falling below the minimum fluid level 44 to a low fluid level 48.

The brake fluid reservoir 10 may include a fluid level detector 50 to detect when the brake fluid level within the fluid chamber 16 is below the minimum fluid level 44 and send a signal to an ECU (not shown) of such information. The ECU can then notify the driver of the vehicle by displaying a visual alert and/or an audible warning that the brake fluid level within the fluid chamber 16 is lower than acceptable and requires attention.

The fluid level detector 50 includes a float 52 which is movably housed and guided within a guide portion 54 of the second chamber portion 16b. The float 52 can be any suitable structure that is buoyant in the brake fluid within the fluid chamber 16 and moves vertically relative to the housing 14 in response to the level or volume of the brake fluid in the fluid chamber. The float 52 may be designed such that it floats almost entirely on top of the brake fluid, partially submerged in the brake fluid, and/or entirely submerged within the brake fluid. The guide portion 54 may be defined by one or more interior walls and/or ribs of the housing 14. The guide portion 54 may be dimensioned or otherwise configured such that the float 52 is permitted to move vertically within the guide portion unhindered while providing guided stability when the float moves within. In other words, the float 52 permitted to move vertically within the guide portion 54, but at least partially prevented from moving in directions that are perpendicular to the vertical direction.

The fluid level detector 50 also includes a sensor assembly 56. The sensor assembly 56 can be any suitable mechanism (e.g., a magnetic sensor or a reed switch) that detects the vertical movement and/or position of the float 52 relative to the housing 14. Determining the position of the float 52 typically corresponds to the brake fluid level within the fluid chamber 16. For example, the sensor assembly 56 may be in the form of a magnetic sensor with an internal hall element that interacts with one or more magnetic elements 57 that are attached to or embedded in the float 52. The sensor assembly 56 is mounted at a predetermined position in or adjacent to the second chamber portion 16b such that detection of the float 52 can be sensed when the float is adjacent to the sensor assembly. In particular, the sensor assembly 56 may be mounted at or adjacent to a vertical position that corresponds to the brake fluid volume being at the low fluid level 48. Therefore, when a predetermined portion of the float 22 falls to the low fluid level 48, the sensor assembly 56 senses the float and transmits a low fluid level signal to the ECU.

While use of the float 52 helps determine when the brake fluid volume is low, certain vehicle maneuvers may urge the brake fluid in the second chamber portion 16b to be displaced to or toward the funneling chamber 28 and/or the first chamber portion 16a. Such brake fluid displacement would typically cause the float 52 in the second chamber portion 16b to sink to the low fluid level 48 even when the brake fluid volume in the fluid chamber 16 corresponds to at least the minimum fluid level 44, thereby falsely triggering a low brake fluid notification. The brake fluid reservoir 10, however, is configured to at least partially prevent such brake fluid displacements and false low brake fluid notifications.

In particular, the brake fluid reservoir 10 includes a valve mechanism 58 that operatively cooperates with the outlet opening 30 to prevent the brake fluid from flowing through the outlet opening from the second chamber portion 16b toward the first chamber portion 16a when the brake fluid volume in the fluid chamber 16 corresponds to at least the minimum fluid level 44. In the example configuration shown in FIG. 1, the valve mechanism 58 comprises the filter mesh 34 that covers the outlet opening 30.

Therefore, in addition to or instead of having contaminant-catching functionality, the filter mesh 34 prevents the undesirable displacement of brake fluid.

The filter mesh 34 is located vertically below the minimum fluid level 44 such that the filter mesh is maintained in a wetted condition by the brake fluid when the brake fluid volume in the fluid chamber 16 corresponds to at least the minimum fluid level.

When wetted, the filter mesh 34 prevents the brake fluid in the second chamber portion 16b from flowing through the outlet opening 30 toward the first chamber portion 16a, thereby preventing the displacement of brake fluid that would otherwise cause the float 52 to prematurely sink to the low fluid level 48. In other words, a surface tension of the brake fluid against the filter mesh 34 forms a fluidic barrier that prevents the brake fluid from flowing through the outlet opening 30 from the second chamber 16b toward the first chamber 16a when the brake fluid volume in the fluid chamber corresponds to at least the minimum fluid level 44. Accordingly, instead of wrongly sinking to the low fluid level 48 and triggering a false low brake fluid level notification, the float 52 may be maintained vertically above the low fluid level, e.g., adjacent to or in direct contact with at least one of the filter mesh 34 and the funnel 20.

In other configurations, the minimum fluid level 44 may be located vertically below the filter mesh 34. In these configurations, vehicle maneuvers that would have otherwise caused the brake fluid displacement cause the brake fluid in the second chamber portion 16b to wet the filter mesh 34 and create the fluidic barrier, thereby preventing brake fluid in the second chamber portion 16b from escaping (and/or further escaping) through the outlet opening 30.

Although the venting opening 36, when provided, provides a secondary pathway for brake fluid displacement, the location and/or dimensions of the venting opening may be such that the braking fluid in the second chamber portion 16b is prevented from flowing through the venting opening toward the first chamber portion 16a. Alternatively, the location and/or dimensions of the venting opening 36 may be such that only insignificant volumes (i.e., volumes less than what would be necessary for sinking the float 52 to the low fluid level 48) of brake fluid may flow from the second chamber portion 16b through the venting opening throughout use of the vehicle.

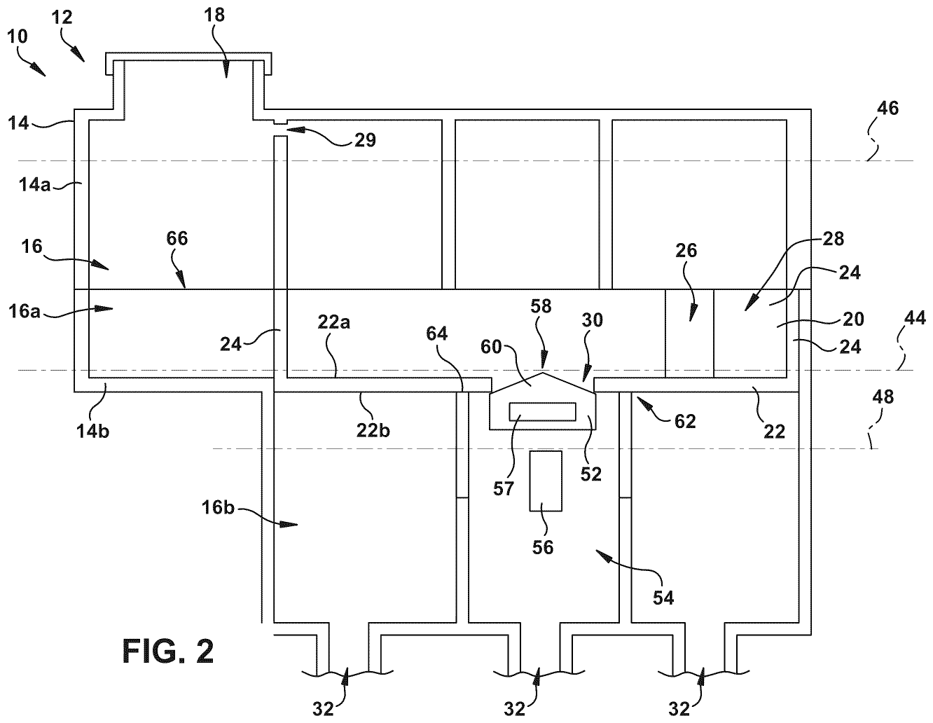

FIG. 2 depicts another configuration of the brake fluid reservoir 10 in which the valve mechanism 58 comprises the float 52. As shown, the float 52 includes a head 60 that is shaped and/or dimensioned to close the outlet opening 30 when the brake fluid volume in the fluid chamber 16 corresponds to at least the minimum fluid level 44. In the example configuration of FIG. 2, the head 60 is conical, though the head may have any other suitable shape. The conical head 60 extends into the outlet opening 30 and/or directly contacts portions of the funnel 20 adjacent to the outlet opening (e.g., directly contacts portions of an outer surface 22b of the end wall 22 that surrounds the outlet opening) to close the outlet opening. The float 52 thus at least partially seals off the outlet opening 30 when the brake fluid volume in the fluid chamber 16 corresponds to at least the minimum fluid level 44 to prevent brake fluid from flowing through the outlet opening from the second chamber portion 16b toward the first chamber portion 16a.

It should be appreciated that the filter mesh 34, the venting opening 36 and the barrier feature 38 are omitted from the brake fluid reservoir 10 of FIG. 2. The funnel 20 of FIG. 2, however, may be configured to include one or both of the venting opening 36 and the barrier feature 38 as desired.

In summary, the provision of the valve mechanism 58 helps prevent the issuance of false low brake fluid notifications by preventing brake fluid in the second chamber portion 16b from being displaced toward the first chamber portion 16a when the brake fluid volume in the fluid chamber 16 corresponds to at least the minimum fluid level 44, though the valve mechanism 58 may also at least partially prevent the brake fluid displacement even when the brake fluid volume in the fluid chamber 16 corresponds to a fluid level that is below the minimum fluid level 44. Therefore, when compared to brake fluid reservoirs that increase the distance between the minimum fluid level and the low fluid level and add a buffer volume of the brake fluid to compensate for the increased distance in an attempt to solve the false low brake fluid notification issue, the brake fluid reservoir 10 of the present disclosure may be smaller (at least in the vertical direction), lighter, and/or cheaper. In particular, when it comes to its vertical height, the brake fluid reservoir 10 may be configured such that the vertical distance between the minimum fluid level 44 and the low fluid level 48 may be about 3 mm to about 8 mm, while the previously known brake fluid reservoirs have an about 12 to about 15 mm distance between their minimum and low fluid levels. This reduction in distance is in part because the presence of the valve mechanism 58 permits the minimum fluid level 44 to be located only slightly vertically above the outlet opening 30, though the brake fluid reservoir 10 may be configured with any desired vertical distance between the minimum fluid level and at least one of the low fluid level line and outlet opening.

Furthermore, the brake fluid reservoir 10 may be configured with the minimum fluid level 44 being vertically below the outlet opening 30 in configurations in which an even more compact brake fluid reservoir is desired.

One example method for assembling a brake fluid reservoir 10 designed in accordance with the teachings of the present disclosure includes providing the housing 14. As shown, the housing 14 may be a multi-piece housing have a first shell 14a, which includes the fill port 18, and a second shell 14b, which includes the connection ports 32. The second shell 14b may also include/define the guide portion 54 when the guide portion is provided. The fluid level detector 50 is added to the second shell 14b with the float 52 being inserted in the second shell (e.g., in the guide portion 54) and the second sensor assembly 56 being mounted to the second shell at or adjacent to the vertical position that corresponds to the brake fluid volume being at the low fluid level 48. The funnel 20 may then be seated in a funnel receiving portion 62 of the second shell 14b such that the outer surface 22b of the end wall 22 rests directly on a corresponding inner support surface 64 of the second shell.

With the fluid level detector 50 and funnel 20 in place, the first shell 14a, the second shell 14b and the funnel 20 are then welded (or otherwise heat sealed) together along a single welding plane 66. The welding plane 66 may at or adjacent to an end of the funnel's side walls 24 that is opposite to the end wall connected-side of the side walls. Therefore, via this single welding plane 66, the first shell 14a, the second shell 14b and the funnel 20 can be maintained connected to one another without the use of additional fastening mechanisms/techniques and without having to secure the funnel to either of the first and second shells prior to welding the shells together. Additionally, it should be appreciated that the funnel 20 is mounted/secured in place as the housing 14 is constructed, not after. When connected, the first shell 14a, the second shell 14b and the funnel 20 define the first chamber portion 16a, the first shell and the funnel define the funneling chamber 28, and the funnel and the second shell define the second chamber portion 16b.

1: A brake fluid reservoir for a vehicle brake system, the brake fluid reservoir comprising:
a housing defining a fluid chamber for brake fluid;
a funnel mounted to the housing in the fluid chamber and defining first and second chamber portions of the fluid chamber, the funnel having an inlet opening via which brake fluid flows into the funnel from the first chamber portion and an outlet opening via which the brake fluid flows into the second chamber portion from the funnel, the outlet opening being vertically below a minimum fluid level and above a low fluid level, a braking circuit connected with the brake fluid reservoir being in a normal operating state when the volume of the brake fluid in the fluid chamber corresponds to at least the minimum fluid level; and
a valve mechanism extending into the outlet opening and configured to at least partially prevent brake fluid from flowing through the outlet opening from the second chamber portion toward the first chamber portion.

2: The brake fluid reservoir recited in claim 1, wherein the valve mechanism comprises a filter mesh that covers the outlet opening.

3: The brake fluid reservoir recited in claim 2, wherein the filter mesh prevents brake fluid from flowing through the outlet opening from the second chamber portion toward the first chamber portion when the filter mesh is wetted by the brake fluid.

4: The brake fluid reservoir recited in claim 2, wherein a surface tension of the brake fluid against the filter mesh forms a fluidic barrier that prevents the brake fluid from flowing through the outlet opening from the second chamber portion toward the first chamber portion when the brake fluid volume in the fluid chamber corresponds to at least the minimum fluid level.

5: The brake fluid reservoir recited in claim 2, wherein the filter mesh is located vertically below the minimum fluid level such that the filter mesh is maintained in a wetted condition by the brake fluid when the brake fluid volume in the fluid chamber corresponds to at least the minimum fluid level, the wetted filter mesh preventing the brake fluid from flowing through the outlet opening from the second chamber portion toward the first chamber portion when the brake fluid volume in the fluid chamber corresponds to at least the minimum fluid level.

6: The brake fluid reservoir recited in claim 2, wherein the filter mesh prevents contaminants from passing through the outlet opening.

7: The brake fluid reservoir recited in claim 6, wherein the housing has a fill port through which the fluid chamber is filled with the brake fluid, the brake fluid reservoir being free of additional contaminant filters between the fill port and the filter mesh.

8: The brake fluid reservoir recited in claim 1, further comprising a fluid level detector, the fluid level detector comprising:
a float in the second chamber portion that moves vertically relative to the housing in response to the volume of the brake fluid in the fluid chamber; and
a sensor assembly for detecting the vertical movement and/or position of the float, the sensor assembly transmitting a low fluid level signal when the float is in a predetermined vertical position that corresponds to the brake fluid volume being at the low fluid level, the float being prevented from sinking to the predetermined vertical position via the valve mechanism when the brake fluid volume in the fluid chamber corresponds to at least the minimum fluid level.

9: The brake fluid reservoir recited in claim 8, wherein the valve mechanism comprises the float, the float closing the outlet opening to prevent brake fluid from flowing through the outlet opening from the second chamber portion toward the first chamber portion when the brake fluid volume in the fluid chamber corresponds to at least the minimum fluid level.

10: The brake fluid reservoir recited in claim 9, wherein the float includes a head that extends into outlet opening and contacts portions of the funnel adjacent the outlet opening to close the outlet opening.

11: The brake fluid reservoir recited in claim 8, wherein the valve mechanism comprises a filter mesh that covers the outlet opening.

12: The brake fluid reservoir recited in claim 11, wherein the float is maintained in contact with at least one of the filter mesh and the funnel when the brake fluid volume in the fluid chamber corresponds to at least the minimum fluid level.

13: The brake fluid reservoir recited in claim 1, wherein the funnel has a venting opening for permitting air to pass out from the second chamber portion during filling of the fluid chamber.

14: The brake fluid reservoir recited in claim 1, wherein the funnel includes an end wall that has the outlet opening and a side wall that extends in a vertical direction from an inner surface of the end wall and has the inlet opening.

15: The brake fluid reservoir recited in claim 14, wherein the end wall includes a venting opening spaced from the outlet opening.

16: The brake reservoir recited in claim 15, wherein the funnel includes a barrier feature at least partially surrounding the venting opening on an inner surface of the end wall, the barrier feature at least partially urging brake fluid in the funnel away from the venting opening.

17: The brake fluid reservoir recited in claim 1, wherein the housing comprises first and second shells that are separately formed and subsequently connected to one another.

18: The brake fluid reservoir recited in claim 17, wherein the first shell, second shell and the funnel are welded together along a single welding plane.

19: The brake fluid reservoir recited in claim 17, wherein the first shell includes a fill port through which fluid is supplied to the first chamber portion, the second shell including at least one connection port that fluidically connects the second chamber portion to a braking circuit of the vehicle.

20: The brake fluid reservoir recited in claim 1, wherein the brake fluid reservoir has a maximum fluid level, the braking circuit of the vehicle being in the normal operating state when the brake fluid volume corresponds to a brake fluid level that is at or between the minimum and maximum fluid levels.
